(19) United States
(12) Patent Application Publication
(10) Pub. No.: US 2004/0228531 A1
(43) Pub. Date: Nov. 18, 2004

(54) Instant messaging user interfaces

(75) Inventors: Roland Fernandez, Woodinville, WA (US); Iain Hackett, Port Vila (VU); Wistar D. Rinearson, Redmond, WA (US); Michael Williams, Seattle, WA (US); Susan D. Woolf, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/437,173

(22) Filed: May 14, 2003

(51) Int. Cl. G06K 9/00; G09G 5/00; G06F 15/16; H04M 1/64

(52) U.S. Cl. 382/187; 345/758; 709/206; 379/88.17; 345/179; 345/173

(57) ABSTRACT

User interfaces and methods are described for managing invitations in instant messaging communication threads. In some aspects, tabs are used to organize instant messaging threads in a condensed structure. In other aspects, a user may send and receive invitations that are then stored pending a receive user's acceptance or decline of the invitation. The status of these pending conversations is continuously displayed to the user so they are not forgotten. These and other aspects to user interfaces for instant messaging applications are described.

### BACKGROUND OF THE INVENTION

1. Field of the Invention

Aspects of the present invention relates to communication techniques. More specifically, aspects of the present invention relate to user interfaces for instant messaging applications.

2. Description of Related Art

Typical computer systems, especially computer systems using graphical user interface (GUI) systems, such as Microsoft WINDOWS, are optimized for accepting user input from one or more discrete input devices such as a keyboard for entering text, and a pointing device such as a mouse with one or more buttons for driving the user interface.

Some computing systems have expanded the input and interaction systems available to a user by allowing the use of a stylus to input information into the systems. The stylus may take the place of both the keyboard (for data entry) as well as the mouse (for control). Some computing systems receive handwritten electronic information or electronic ink and immediately attempt to convert the electronic ink into text. Other systems permit the electronic ink to remain in the handwritten form.

Instant messaging applications currently exist. AOL® Instant Messenger™ 5.1 and MSN® Instant Messenger 5.0 are messaging applications that permit to one to transmit text, images, and other files to people on one's contact list. Other instant messaging applications are available. One common aspect of these instant messaging applications is that they all are limited to text as the primary information to be exchanged. If one wants to transfer an image or a file, one needs to request the recipient to accept the file. Stylus-based computing is not always predicated on the ability to input text. Accordingly, instant messaging applications need to be able to handle electronic ink from stylus-based computing applications as easily as they handle text.

Further, instant messaging is becoming increasingly popular as users are able to send and receive instant messages from portable devices. These portable devices include cell phones, personal data assistants, handheld computers and notebook computers. A number of these devices do not include full-fledged keyboards, but rather rely on a minimal keyboard or a stylus-based input system to receive information from a user. Instant messaging services need to be able to accommodate stylus-based input without creating hassles for users.

Handling instant message communications is relatively straightforward. One receives a communication from another and responds. However, when a person receives multiple communication requests, organizing and responding to these multiple requests is cumbersome. For example, a celebrity may receive numerous instant messaging requests in a short period of time. These multiple requests can easily confused and disorient the user in having to wade through randomly appearing windows to continue a conversation with one or two others. Accordingly, a better way to handle conversations is needed.

Further, instant messaging can be used to cloak one's identity. This cloaking, while at times may be intentional, is at other times unintentional. Often, one is forced to choose a contact name or identifier that is relatively cryptic or not descriptive enough for use with large numbers of contacts. Accordingly, an improved and richer way of communicating a person's identity and possible interests is needed.

### BRIEF SUMMARY

Aspects of the present invention address one or more of the issues mentioned above, thereby providing a better instant messaging environment. Aspects of the present invention include various user interfaces that provide the ability to send and receive invitations to conversations, manage conversations, directly manage color and size palettes, manage contacts, and obtain more information about contacts.

These and other aspects are addressed in relation to the Figures and related description.

### BRIEF DESCRIPTION OF THE DRAWINGS

Aspects of the present invention are illustrated by way of example and not limited in the accompanying figures.

FIG. 1 shows a general-purpose computer supporting one or more aspects of the present invention.

FIG. 2 shows a display for a stylus-based input system according to aspects of the present invention.

FIG. 3 shows a user interface in accordance with aspects of the present invention.

FIG. 4 shows another user interface in accordance with aspects of the present invention.

FIGS. 5A through 5D show user interfaces associated with accepting and declining invitations in accordance with aspects of the present invention.

FIGS. 6A through 6B show user interfaces associated with waiting for an invitation to be accepted in accordance with aspects of the present invention.

FIG. 7 shows a process for handling invitation acceptances in accordance with aspects of the present invention.

FIG. 8 shows a user interface for directly modifying ink in accordance with aspects of the present invention.

FIG. 9 shows a user interface with an image of a user in accordance with aspects of the present invention.

FIG. 10 shows a user interface for adding additional contacts to a contact list in accordance with aspects of the present invention.

FIG. 11 shows an illustrative network topology in accordance with aspects of the present invention.

### DETAILED DESCRIPTION OF THE DRAWINGS

Aspects of the present invention are directed to improved instant messaging organizational techniques and information conveyance techniques. Using aspects of the present invention, one may be able to handle large numbers of contacts and potential opportunities for instant messaging communications. The following description is divided into various headings to assist the user in understanding aspects of the present invention. The headings include: characteristics of ink; terms; general-purpose computer; managing instant communication threads; direct control of instant message ink; and user information.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, T), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink) among other information.

Terms

Ink—A sequence or set of strokes with properties. A sequence of strokes may include strokes in an ordered form. The sequence may be ordered by the time captured or by where the strokes appear on a page or in collaborative situations by the author of the ink. Other orders are possible. A set of strokes may include sequences of strokes or unordered strokes or any combination thereof Further, some properties may be unique to each stroke or point in the stroke (for example, pressure, speed, angle, and the like). These properties may be stored at the stroke or point level, and not at the ink level.

Ink object—A data structure storing ink with or without properties.

Stroke—A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point—Information defining a location in space. For example, the points may be defined relative to a capturing space (for example, points on a digitizer), a virtual ink space (the coordinates in a space into which captured ink is placed), and/or display space (the points or pixels of a display device).

General-Purpose Computer

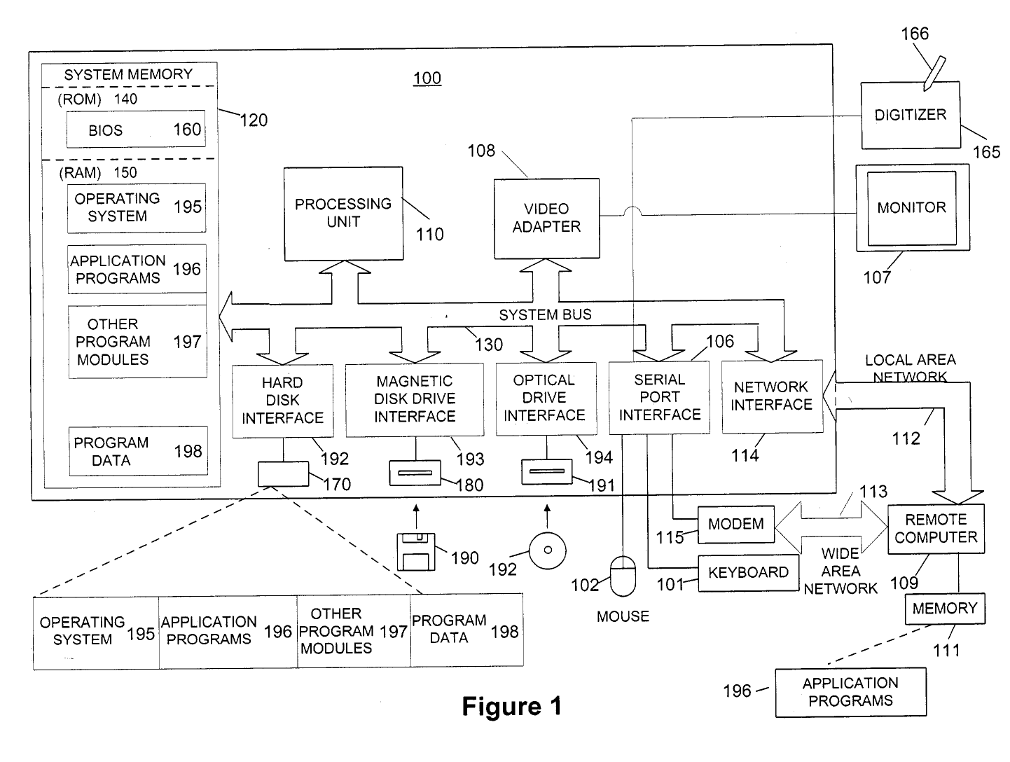

FIG. 1 illustrates a schematic diagram of an illustrative conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a one embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device. Further, the system may include wired and/or wireless capabilities. For example, network interface 114 may include Bluetooth, SWLan, and/or IEEE 802.11 class of combination abilities. It is appreciated that other wireless communication protocols may be used in conjunction with these protocols or in place of these protocols.

It will be appreciated that the network connections shown are illustrative and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

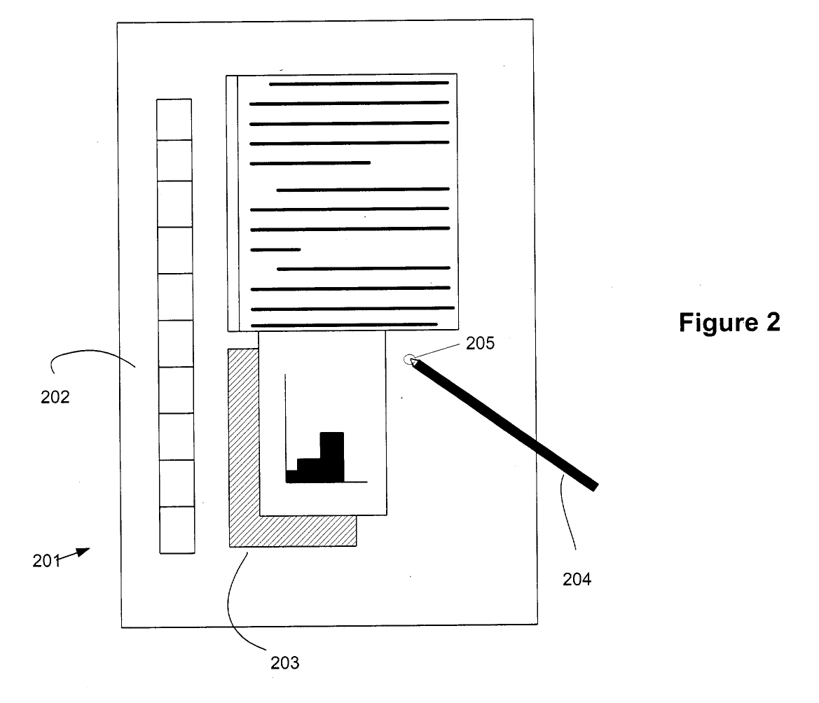

FIG. 2 illustrates an illustrative tablet PC 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 as contacted the display surface 202.

In various embodiments, the system provides an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the. Net programming model from Microsoft Corporation.

Managing Instant Communication Threads

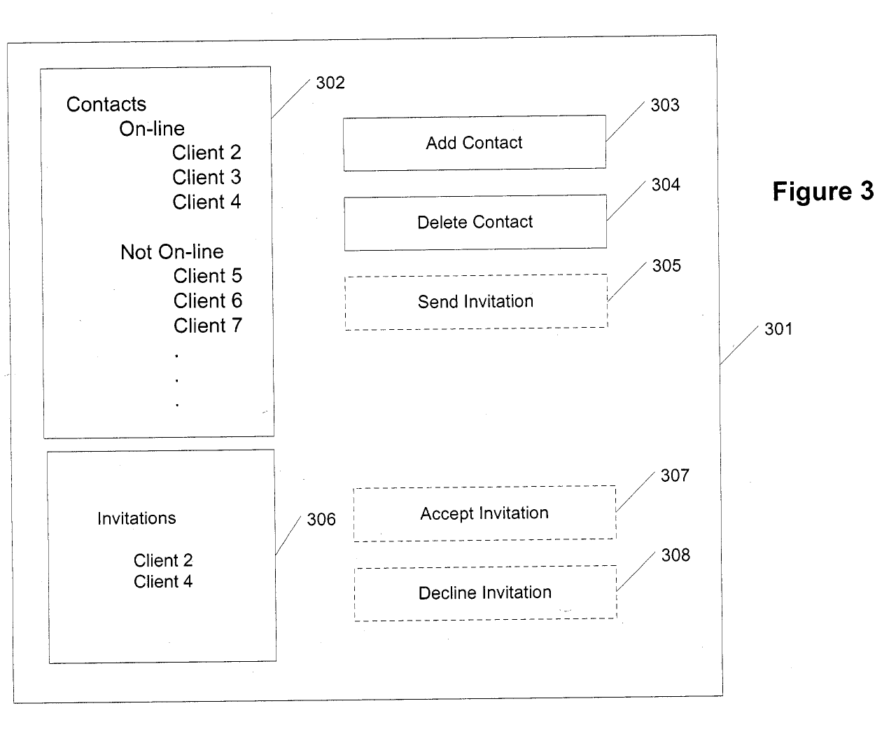

FIG. 3 shows a user interface in accordance with aspects of the present invention. FIG. 3 includes region 301 that includes a list of contacts in region 302 and a list of received and/or pending invitations in region 306. The regions as shown in FIG. 3 and the following figures may be windows or may also include groups of information as displayed on a display device. So, for example, a cellular telephone (or PDA, notebook PC, portable device and the like) may have a list of contacts 302 and a list of invitations 306 displayed at the same time or on separate screens. The list of contacts 302 includes contacts representing other users or other entities (besides those explicitly entered by the user) with whom the present user may attempt to establish an instant messaging communication.

The contacts in region 302 may or may not be grouped into sets including but not limited to, online/not online, work/friends, and other groups as are known in the art. Options may be available for a user to modify the list of contacts in region 302. For example, one may add a contact by selecting region 303. Also one may delete a contact by selecting on region 304. These selection operations may occur through operation of one or more mouse buttons, operation of a handheld stylus or pen, or pressing a button on a control or keyboard. Further, these options 303 and 304 may be accessible through a displayed menu.

For purposes of explanation, the representations of users in region 302 are referred to as clients. Here, clients 2-4 are online while clients 5-7 are not online. Region 306 shows invitations received from clients 2 and 4.

Another option available to a user includes sending an invitation to one of the contacts in region 302 to initiate a conversation. Invitations provide the benefit of allowing a user to manage instant messaging conversations. Instead of having numerous instant messaging windows open at any given moment, one may delay accepting an invitation to chat until a later time. So, for instance, where a user receives numerous instant message communications, the user may only accept invitations that one desires to currently engage, while declining or ignoring pending invitations.

One may interact with a region 305 to initiate a sending of an invitation to another user. Also one may select one or more of the contacts in region 302 and have an invitation sent to a user associated with a contact.

A user may accept an invitation by selecting one of the invitations as shown in region 306. Alternatively, one may accept an invitation by selecting region 307. One may decline an invitation by indicating on one of the invitations (for instance, by selecting a menu option). Alternatively, one may ignore an invitation for a predetermined amount of time and the invitation may be automatically withdrawn after some default or user-defined period of time. In short, a variety of methods exist for accepting and declining invitations, only of which some are identified here.

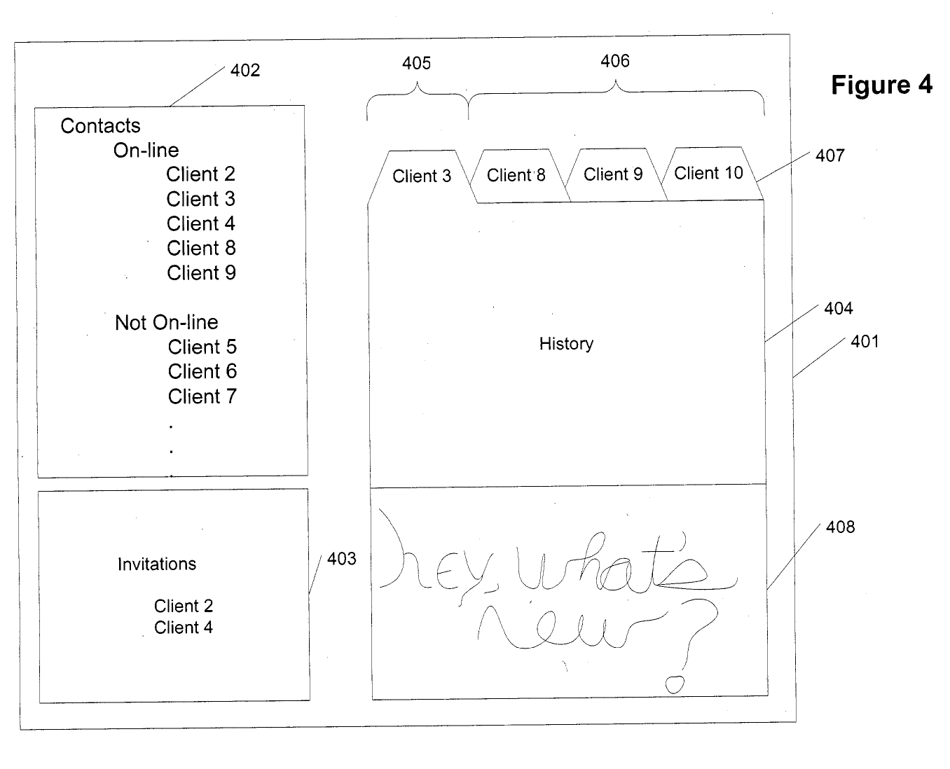

FIG. 4 shows another user interface in accordance with aspects of the present invention. FIG. 4 includes region 401 that also includes a list of contacts 402, a list of invitations 403, newly entered information 408, and an instant messaging history region 404. To manage various instant messaging communication threads, a user may be provided with a variety of tabs 405 and 406 that representing active and inactive communication threads. Here, tab 405 relates to an active communication between the user and client 3. Tabs 406 representing inactive communication threads with clients 8, 9, and 10. In the case of a particularly large or multiple simultaneous displays providing greater desktop real estate, it may not be desirable to keep all conversations within a single tabbed area. It should be appreciated that each tab may be undocked from the other tabs and float separately within the user's field of view. It is noted that not all communication threads need to be associated with contacts in contact list 402. For example, client 10 at tab 407 in collection of tabs 406 is not a stored contact appearing in list 402 of the user.

A further use of the multiple sessions being managed by the tabbed regions is to join or separate synchronous sessions. This may be accomplished through the user interface methods of dragging tabs together, right-clicking on an individual tab (press and hold with a stylus) in order to evoke a list of all current sessions. Dropping a session from a joint conversation is accomplished through the same actions.

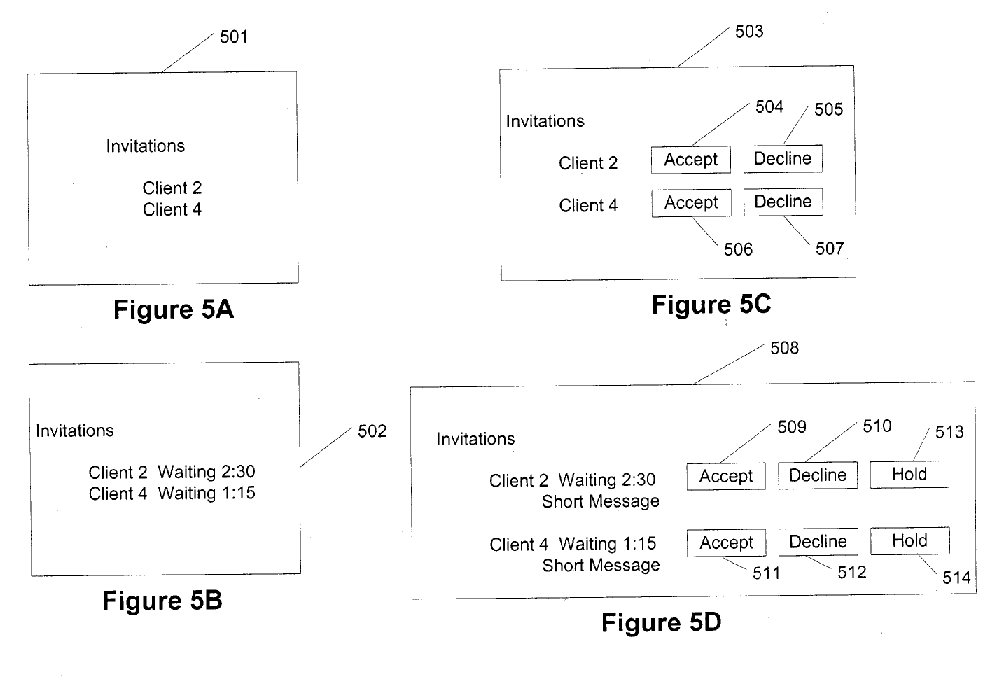

FIGS. 5A through 5D show user interfaces associated with accepting and declining invitations in accordance with aspects of the present invention. FIG. 5A shows an invitation region 501 showing two pending invitations for a user. Here, a user has pending invitations from client 2 and client 4. FIG. 5B shows region 502 with pending invitations from clients 2 and 4. In addition to showing invitations from client 2 and client 4, FIG. 5B shows the elapsed time since the invitations were received. FIG. 5C shows region 503 with invitations from clients 2 and 4 with explicit regions 504 and 506 to accept the invitations and explicit regions 505 and 507 to decline the invitations (regions 504 and 505 relating to client 2 and regions 506 and 507 relating to client 4). FIG. 5D shows region 508 including invitations from client 2 and client 4 and includes a possible short message from each client. For example, a user may send an invitation to another to start or join in a conversation. In some situations, it may be beneficial to include a short message with the invitation to alert the receiver of the topic of a conversation or a simple question. Accordingly, the person receiving the invitation may see the short message and be able to leave the invitation pending while addressing other matters. FIG. 5D also shows additional fields including a waiting time indicator as well as accept/decline regions 509, 510, 511, and 512 for clients 2 and 4, respectively. As an alternative to displaying the waiting time for an invitation, the system may display the time the invitation was received or sent.

Further, another aspect includes a button (or menu item or the like) that relates to a pending invitation. Buttons 513 and 514, upon interaction, send client 2 or client 4 (depending on which button was activated) who sent the invitation an ink message that effectively notifies the invitation sender that the invitation has been noticed and the receiver will respond later. For instance, the message may read “Please hold on—I'll get to you as soon as I can”. This message may be customizable by the user to include any message he chooses, in his own handwriting (ink). This way, if a user sees someone he doesn't want to ignore or cancel or refuse the invitation but is too busy to start a conversation with him at the moment, the one who received the invitation may just press button 513 or 514 to let the invitation sender know that he sees the invitation and wants to talk to him, and will begin the conversation in due course.

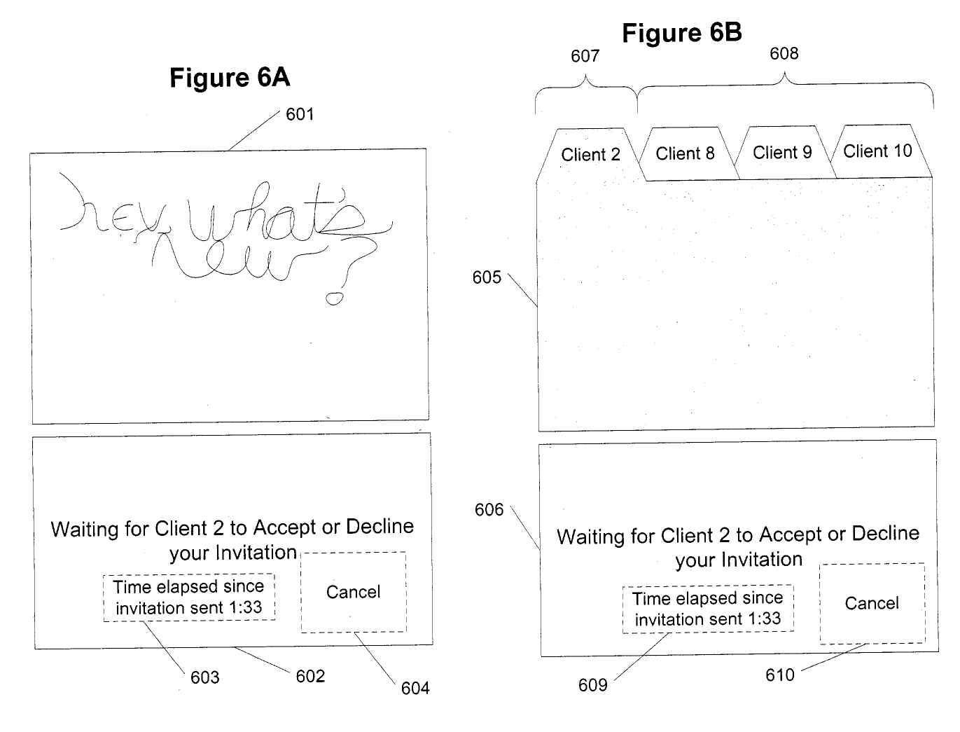

FIGS. 6A through 6B show user interfaces associated with waiting for an invitation to be accepted in accordance with aspects of the present invention. One of the advantages of showing some indication to a user sending an invitation to another user that the other user has yet to accept an invitation includes the sending user knowing that the instant message conversation has yet to begin. FIG. 6A includes region 601 as a history window showing sent and received instant messages and region 602, which displays a message from a user to another indicating that a current invitation is pending with the other user. Region 602 may only include a message that an invitation is currently pending or may also include additional information. For example, region 603 may be shown that includes time elapsed since an invitation was sent. Alternatively region 603 may display the time the invitation was sent. Further, region 602 may also include (or be near, though not shown for simplicity) a region 604 that permits a user to cancel or rescind an invitation.

FIG. 6B shows history region 605 and region 606, which indicates that a party receiving a current user's invitation has yet to accept or decline the invitation. Region 606 may also include or be near region 609 that indicates a time elapsed since an invitation was sent or the time an invitation was sent. Further, region 606 may also be near or include a region 610 that permits a user to withdraw or rescind an invitation. FIG. 6B also includes history area 605 that may be grayed out or otherwise indicated as being disabled to receive input. FIG. 6B further may include tabs 607 and 608 that permit a user to switch between sent and pending invitations, open instant message threads, or a combination of both. Here, region 607 relating to an invitation sent to client 2 is shown as being on available to a user. Tabs represented by group 608 may relate to active instant message communication threads from clients 8-10.

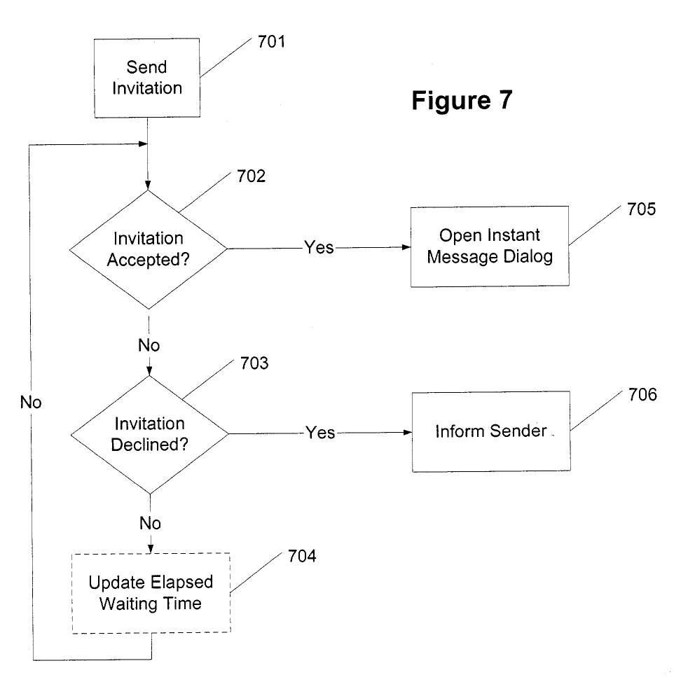

FIG. 7 shows a process for handling invitation acceptances in accordance with aspects of the present invention. In step 701a, a user sends an invitation to another user. In step 701b, a conversation window is opened and put into its “waiting” state. In step 702 a user's system determines if the invitation was accepted. If yes from step 702, the conversation window is put into its normal, enabled state and the conversation between the user and the other user in step 705 can take place. If no from step 702, the system determines if an invitation was declined in step 703. If yes from step 703, the system informs the user who sent the invitation in step 706 and closes the conversation window. If no from step 703, the system waits for the invitation to be accepted or declined. In an alternative aspect, the system may update the elapsed waiting time for the user who sent the invitation, so as to provide an indication of the amount of time between the sending of the invitation and a current time. It is appreciated that the process of FIG. 7 may also be expressed as an event-driven model as well.

Direct Control of Instant Message Ink

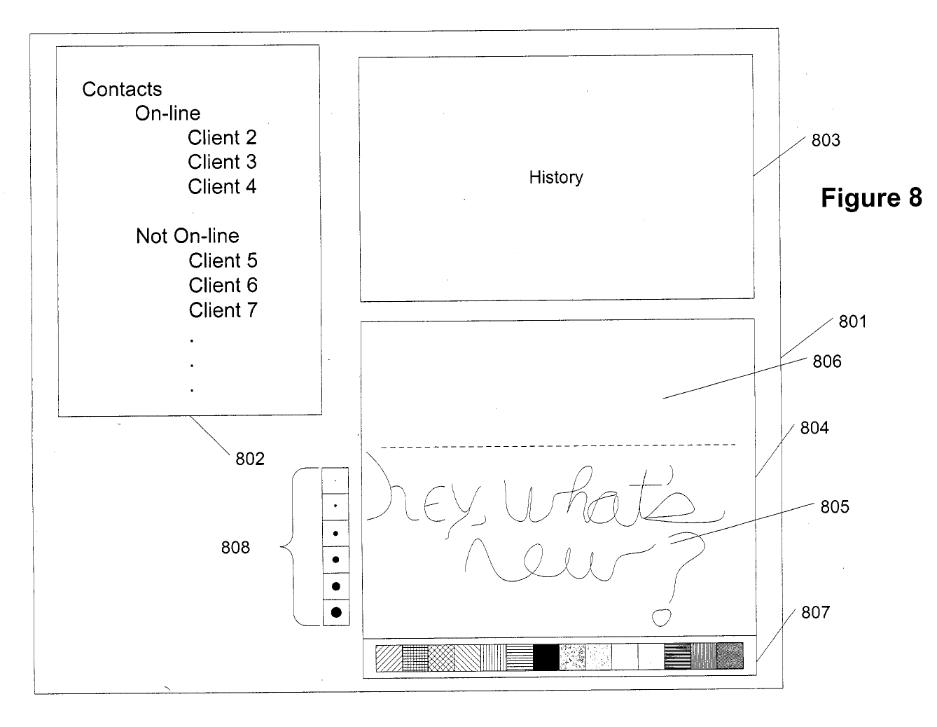

FIG. 8 shows a user interface for directly modifying ink in accordance with aspects of the present invention. FIG. 8 includes region 801 including contacts 802 and history region 803. Current ink input area 804 may include one or more regions near it that permits one to directly change the size and or color of ink to be deposited in region 804. For example, a user may modify the color of ink to be deposited in region 804 by tapping on a color in region 807. In another aspect of the present invention, a user may change the size of the pen tip used for creating ink for region 804 by selecting an ink tip size from region 808. Region 808 may only include pen tip sizes as shown or may also include shapes of pen tips as well. Region 804 may also be split into two additional regions 805 and 806 for accepting ink. Region 805 may accept ink from a current user. Region 806 may show ink currently being deposited by another user. The existence of region 806 provides an interaction between the current ink being deposited by a remote user and the present user by the present user being able to view for ink in a process being deposited by the other user.

In another aspect, the user may select from a set of predefined multimedia responses to include in his message. These responses may include (but not limited to): pre-inked messages (user's handwriting or an artist's), predefined text messages (from user or other source), icons (still and animated), sounds, and the like. This would give the user fast entry of “high design value” media that enhance the user's mood or message.

User Information

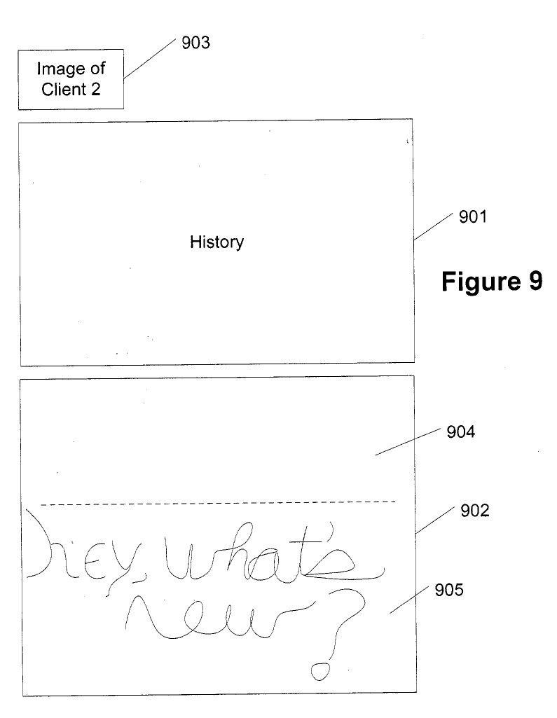

FIG. 9 shows a user interface with an image of a user in accordance with aspects of the present invention. FIG. 9 includes history region 901 and current ink receiving area 902. Visual attributes such as a gray background to region 901 can help the user understand that no further ink can be added to the display of history, in contrast with a white or paper-like blue lined “live” area in 902 which invites ink marking. Ink receiving area 902 may be one area for receiving ink or may include two or more regions for receiving ink as shown by regions 904 and 905. FIG. 9 also shows region 903 that may include an image of the user with whom the present user is instant messaging. In this example, the image of client 2 is shown. The appearance of a photograph of the user with whom a present user is communicating provides a more personalized instant messaging environment.

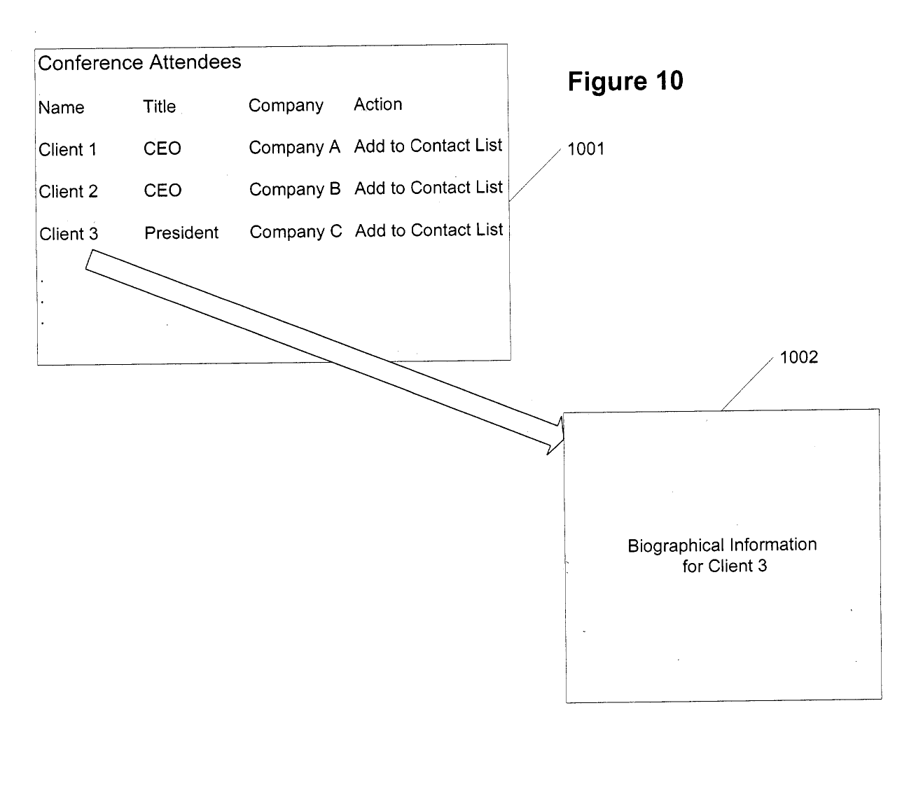

FIG. 10 shows a user interface for adding additional contacts to a contact list in accordance with aspects of the present invention. FIG. 10 shows information as set 1001. Upon selection of a client name, for example, who are attending a conference, one may able to view information relating to a selected client name. Also, the information in set 1001 may also include a selectable region (here, “add to contact list”), where upon selection thereof, the contact is added to one's contact list. In this aspect of the invention, this is an improvement over the prior art where one would have to engage in a conversation prior to obtaining the contact name, then being able to add that person into a contact list. Also, this is an advantage over situations where one would type in a contact name to have the name added to a contact list.

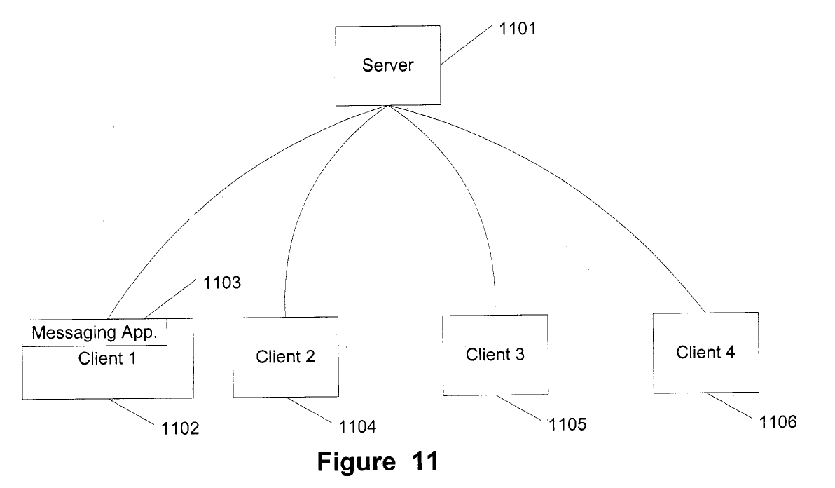

FIG. 11 shows a networked topology in accordance with aspects of the present invention. FIG. 11 includes a server 1101 and a number of clients all interconnected through a wired or wireless network. The wireless aspects of the network may include IEEE 802.11*(any of the IEEE 802.11 family of wireless protocols), Bluetooth, and any other wireless protocol. Client 1 1102 includes a messaging application 1103. The messaging application 1103 is responsible for listening for instant messages from other clients or servers and coordinating appropriate application openings and closings. FIG. 11 shows clients 2 1104, 3 1105, and 4 1106. These clients may also have messaging application 1103 running as well. Alternatively, they may have other messaging applications running. For example, one may have a messaging application 1103 from a first company and another client may have messaging application from a second company.

Aspects of the present invention have been described in terms of illustrative embodiments thereof. Numerous other embodiments, modifications and variations within the scope and spirit of the appended claims will occur to persons of ordinary skill in the art from a review of this disclosure.

We claim:

1. A user interface comprising:
a first region including contacts of a first user;
a second region including invitations to conversations from other users.

2. The user interface according to claim 1, wherein at least one of said invitations is from a second user represented as one of said contacts of said first user.

3. The user interface according to claim 1, wherein at least one of said invitations is from a second user not represented as one of said contacts of said first user.

4. The user interface according to claim 1, further comprising:
a third region where, upon actuation of, an invitation is sent to at least one of said contacts of said first user.

5. The user interface according to claim 1, further comprising:
a list of menu options that are displayed upon a request from said first user, said list of menu items including the option of sending an invitation to at least one of said contacts of said first user.

6. The user interface according to claim 1, wherein an invitation is sent to at least one of said contacts of said first user based on interaction with a listing of at least one of said contacts in said first region.

7. The user interface according to claim 1, further comprising:
a third region where, upon interaction with, an invitation in said second region is declined.

8. The user interface according to claim 1, further comprising:
a third region where, upon interaction with, an invitation in said second region is accepted

9. The user interface according to claim 1, wherein, upon interaction with at least one of said invitations in said second region, said first user accepts at least one of said invitations.

10. A user interface comprising:
a first region for accepting input information;
a second region displaying previous input information from a first user and at least a second user; and
a third region displaying previously input information from a first user and at least a third user, wherein said first user may select between said second region and said third region by interacting with displayed tabs.

11. The user interface according to claim 10, wherein said first region accepts electronic ink.

12. The user interface according to claim 11 wherein at least one of said second region and said third region displays received electronic ink.

13. The user interface according to claim 10, further comprising:
a fourth region including contacts of said first user,
wherein at least one of said second region and said third region reflects a conversation with at least one of said contacts of said first user.

14. The user interface according to claim 10, further comprising:
a fourth region including contacts of said first user,
wherein at least one of said second region and said third region reflects a conversation not including at least one of said contacts of said first user.

15. The user interface according to claim 10, further comprising:
a fourth region including contacts of said first user; and,
a fifth region showing invitations received from at least one of said contacts.

16. A user interface for instant messaging exchanges comprising:
a first region listing one or more invitations from at least one or more contacts of a first user,
wherein the selection of said at least one or more contacts results in the acceptance of an invitation to conversation.

17. The user interface according to claim 16, wherein said listing of said one or more invitations includes time elapsed since receiving said invitation.

18. The user interface according to claim 16, wherein said listing of said one or more invitations includes the time when said invitation was received.

19. The user interface according to claim 16, further comprising:
a second region, wherein interaction with said second region declines an invitation of said one or more invitations.

20. The user interface according to claim 19, further comprising:
a third region, wherein interaction with said third region accepts an invitation of said one or more invitations.

21. The user interface according to claim 16, wherein the selection of said at least one or more contacts provides a list of menu options including accepting the invitation and declining the invitation.

22. A user interface for displaying a temporary display comprising:
a first region displaying a message to a first user regarding an invitation sent from said first user to a second user to engage said second user in an instant messaging conversation.

23. The user interface according to claim 22, further comprising:
a second region that displays time elapsed since said invitation was sent from said first user.

24. The user interface according to claim 22, further comprising:
a second region upon whose interaction said first user may cancel said invitation.

25. The user interface according to claim 24, further comprising:
a third region displaying information sent with said invitation.

26. The user interface according to claim 25, wherein said information includes electronic ink.

27. The user interface according to claim 22, further comprising:
a second region being displayed to a user upon waiting for said invitation to be accepted and wherein said second region is a region for displaying a history of a conversation between users.

28. A method for managing invitations for instant messaging communications comprising the steps of:
sending an invitation from a first user to a second user;
determining if said invitation has been accepted by said second user; and,
opening an instant message dialogue between said first user and said second user.

29. The method according to claim 28, further comprising the steps of:
determining if said invitation has been declined by said second user; and,
informing said first user of the declined invitation.

30. The method according to claim 28, further comprising the steps of:
updating an elapsed waiting time; and,
displaying said elapsed waiting time to said first user.

31. A user interface for sending electronic ink as an instant messaging communication comprising:
a first region displaying previous instant messages between at least first and second users;
a second region displaying electronic ink entered by said first user;
a third region displaying at least two colors, upon selection thereof by said first user, that modify the color of electronic ink to be placed within said second region.

32. The user interface according to claim 31, further comprising:
a fourth region displaying selectable pen tip sizes for use when creating in said electronic ink.

33. The user interface according to claim 31, further comprising:
a fourth region displaying ink in the process of being drawn by said second user before entry into said first region.

34. A user interface for sending electronic ink as an instant messaging communication comprising:
a first region displaying previous instant messages between at least first and second users;
a second region displaying electronic ink entered by said first user; and,
a third region displaying an image of said second user.

35. The user interface according to claim 34, further comprising:
a fourth region displaying ink in the process of being drawn by said second user before entry into said first region.

36. A user interface for adding one or more contacts to a list of contacts for use with an instant messaging application comprising:
a displayable set of information regarding one or more contacts, each of said contacts having some information, upon whose selection thereof, adds with said contacts as a contact in said instant messaging application.

37. The user interface according to claim 36, further comprising:
additional information relating to said one or more contacts, upon whose selection thereof, displays additional information regarding at least one of said selected contacts.
